(19) United States
(12) Patent Application Publication
(10) Pub. No.: US 2025/0034481 A1
(43) Pub. Date: Jan. 30, 2025

(54) DEVICE AND METHOD FOR PREPARING FATTY ACID DERIVATIVES

(71) Applicant: Pathwel Co., Ltd, Jincheon-gun (KR)

(72) Inventors: Young Kee MOON, Seoul (KR); Won Jin KIM, Jincheon-gun (KR); In Dong YEO, Gyeongju-si (KR); Hyun Soo MOON, Seoul (KR); Won Wan KIM, Yeosu-si (KR); Chang Woo YU, Pohang-si (KR)

(73) Assignee: Pathwel Co., Ltd, Jincheon-gun (KR)

(21) Appl. No.: 18/667,612

(22) Filed: May 17, 2024

(30) Foreign Application Priority Data
Jul. 25, 2023 (KR) 10-2023-0096897

(51) Int. Cl. C11C 1/02

(52) U.S. Cl. CPC C11C 1/02

(57) ABSTRACT

Disclosed are a device and method for preparing fatty acid derivatives and more specifically, a device for preparing fatty acid derivatives including three reactors and a method for effectively preparing fatty acid derivatives. The device for preparing fatty acid derivatives including three reactors enables a stable supply of reactants even if a problem occurs in one reactor, and enables continuous and stable operation because delays in the treatment and purification process do not occur. As a result, the device has effects of increasing productivity and reducing production costs. In other words, by operating three reactors instead of two reactors, it is possible to build a production facility that can be operated continuously without stopping, resulting in increased production and reduced production costs. The reactors are operated at a time interval so that only one ammonia feeder and one ammonia collector may be used for all three reactors. As a result, there is no need to prepare additional ammonia feeders and collectors, and there are advantages such as reducing utility costs for preparation.

This application claims the benefit of Korean Patent Application No. 10-2023-0096897, filed on Jul. 25, 2023, which is hereby incorporated by reference as if fully set forth herein.

### BACKGROUND

### Field

The present disclosure relates to a device and method for preparing fatty acid derivatives and more specifically, to a device for preparing fatty acid derivatives including three reactors and a method of effectively preparing fatty acid derivatives.

### Discussion of the Related Art

Fatty acid derivatives are very beneficial substances that are widely used as raw materials for surfactants, soap, cosmetics, pharmaceuticals, lubricants, or biodiesel. Fatty acid derivatives may be produced by reaction (amidation) of fatty acids with ammonia (NH₃) or esterification. Fatty acid derivatives are known substances, various types of which have been produced for a long time.

A method of preparing fatty acid derivatives using ammonia generally includes reaction, treatment, purification, powdering and packaging.

Currently, technological research and development to prepare fatty acid derivatives in the related field are slow due to the small number of companies involved. In particular, there is urgent need for the development of technology that provides higher efficiency in the reaction process that determines the production speed of fatty acid derivatives.

Fatty acid derivatives are prepared by synthesis using reactants (fatty acids and ammonia) over a sufficient period of time in a reactor in the presence of nitrogen atmosphere at a high temperature and a high pressure. Fatty acid derivatives are prepared using a batch process instead of a continuous process to control reaction time and achieve uniform quality. Here, the continuous process refers to a process in which feed and discharge flow continuously during the reaction, and is used in relatively great quantity production. On the other hand, the batch process refers to a process in which reactants are suppled only at the beginning of the process and are reacted for a predetermined period of time without feed or discharge while the reactor is blocked, and then the product is discharged. In other words, no exchange of materials from foreign materials occurs until the reaction is completed, and the batch process is mainly used for relatively small quantity production.

Likewise, the preparation of fatty acid derivatives has a limit to the throughput because the batch process is basically used. The batch operation method is a process in which reactants are fed to the reactor, the reactor is shut off, the reaction is performed for a predetermined period of time without feed or discharge, and then the product is discharged. The batch process requires long equipment shutdown time and a lot of energy for repeated heating and depressurization for operation.

For these reasons, fatty acid derivatives are prepared using a batch-type reaction process and a continuous-type purification process.

Most conventional methods of preparing fatty acid derivatives are performed using a single reactor in the reaction process. Meanwhile, Korean Patent No. 10-1436285 discloses a device for preparing fatty acid derivatives using two reactors. The two reactors still failed to achieve maximum efficiency and malfunction of one of the reactors results in lost time and reduced efficiency. In other words, there is no major problem in the purification process when two reactors are operated normally, but the purification process cannot be operated continuously and thus stops, resulting in a great deterioration in productivity, when the process is delayed in the reaction preparation stage.

Therefore, in order to secure the economic feasibility of the final product, there is an urgent need to develop a method with a modified batch process for bulk processing and long-term stable operation.

### SUMMARY

The present disclosure addresses at least the above-mentioned problems and/or disadvantages and provides at least the advantages described below. Accordingly, an aspect of the present disclosure is to achieve maximum efficiency in the reaction process using three reactors for large-capacity processing and long-term stable operation, and perform stable operation without stopping the process by stably feeding reactants in the continuous process.

Another aspect of the present disclosure is to provide a method of configuring a device for preparing fatty acid derivatives to maximize operation of three reactors in the process of using the three reactors and a method of controlling the device.

Another aspect of the present disclosure is to provide optimized preparation steps and reaction conditions in the preparation of fatty acid derivatives.

Additional aspects will be set forth in part in the description which follows and, in part, will be apparent from the description, or may be learned by practice of the presented embodiments of the disclosure.

According to the present disclosure, a device for preparing fatty acid derivatives includes a reactor configured to react fatty acids, the reactor including a first reactor, a second reactor, and a third reactor, the first, second, and third reactors being connected in parallel, an ammonia feeder configured to feed ammonia and be connected to each of the first, second and third reactors, an ammonia collector configured to collect ammonia and be connected to each of the first, second and third reactors, a disposer configured to separate the reacted fatty acid derivative from the fatty acid reacted in the reactor, and a purifier configured to purify the reacted fatty acid derivative separated by the disposer, wherein the ammonia feeder and the ammonia collector are connected to each other to exchange ammonia, and all of the first, second, and third reactors receive ammonia from the ammonia feeder, and the first, second and third reactors are operated at a time interval from each other to complete each cycle, the fatty acid derivatives that have completed the reaction in the first, second and third reactors are sequentially and continuously fed into the disposer, and each reactor has an idle time after one cycle.

According to the present disclosure, a method of preparing fatty acid derivatives includes raw material feeding of feeding fatty acid to a reactor, gas exchange of feeding nitrogen to the reactor to make the atmosphere of the reactor inert, reactor temperature raising of raising an internal temperature of the reactor to 120° C. or higher, reaction including feeding ammonia to the reactor using an ammonia feeder to perform a reaction with fatty acids, aging to allow the reaction to complete while controlling an amount of ammonia fed and maintaining the reactor temperature, depressurization of stopping the feed of ammonia and removing the pressure in the reactor, and transfer of transferring the depressurized reactants inside the reactor.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates three reactors, an ammonia feeder and an ammonia collector of a device for preparing fatty acid derivatives according to the present disclosure; and

FIG. 2 illustrates an example of reactor system comparison.

### DETAILED DESCRIPTION

Hereinafter, preferred embodiments of the present disclosure will be described in more detail with reference to the annexed drawings. Various modifications and implementations of the present disclosure are possible and will be described in detail. However, the present disclosure is not limited to the following examples and a variety of modifications, equivalents and alterations are possible without departing from the ideas and scope of the present disclosure.

The terminology used herein is provided only for describing specific embodiments and should not be construed as limiting the scope of the present disclosure. Singular forms are intended to include plural forms as well, unless the context clearly indicates otherwise.

In addition, all the terms including technical and scientific terms used herein have the same meanings as commonly understood by those skilled in the art, unless otherwise mentioned. Terms as defined in commonly used dictionaries should be interpreted as having meanings consistent with the meanings they have in the context of the related technology, and should not be interpreted in an idealized or overly formal sense unless clearly defined herein.

A device for preparing fatty acid derivatives according to the present disclosure includes a reactor configured to react fatty acids, the reactor including a first reactor, a second reactor, and a third reactor, the first, second, and third reactors being connected in parallel, an ammonia feeder configured to feed ammonia and be connected to each of the first, second and third reactors, an ammonia collector configured to collect ammonia and connected to each of the first, second and third reactors, a disposer configured to separate the reacted fatty acid derivative from the fatty acid reacted in the reactor, and a purifier configured to purify the reacted fatty acid derivative separated by the disposer.

The device for preparing fatty acid derivatives includes a powderizer for powdering the fatty acid derivative purified by the purifier and a packager for packaging the powdered fatty acid derivative.

Fatty acids used in the present disclosure include erucic acid, oleic acid, stearic acid, behenic acid and the like, and fatty acid derivatives are prepared by reacting ammonia with the fatty acids.

In the present disclosure, the reactor includes a reaction tank, a stirrer provided inside the reaction tank, a heater provided outside the reaction tank, and an insulator configured to insulate all or part of the heater and the reaction tank while surrounding the heater and the reaction tank. In addition, the insulator may be configured such that an aerogel insulation layer surrounds the heater provided outside the reaction tank and the outside of the reaction tank.

In the present disclosure, the types and shapes of the first, second, and third reactors may be the same or different from each other, and may be modified depending on the objects to be achieved.

When the three reactors according to the present disclosure are used, there are more variables for controlling the amount of ammonia fed from one ammonia feeder to each reactor in a stepwise manner, compared to when one or two reactors are used. Each reactor preferably further includes at least one of an ammonia flow regulator, an automatic valve, or an emergency shut-off valve.

The ammonia flow controller or ammonia flow meter is a device that indicates the amount of ammonia fed to the reactor and is in combination with the automatic valve to precisely control the amount of fed ammonia, and contributes to stable reaction.

The automatic valve is a valve that precisely controls the flow of fluid in combination with the ammonia flow meter and has the advantage of being very convenient to operate as the opening and closing of the valve can be controlled automatically rather than manually. The automatic valve is used to smoothly and precisely regulate the fluid flow by changing the size of the passage through which fluid flows depending on a signal from the controller. The automatic valve functions to directly control the flow rate and to control process parameters such as pressure, temperature, and level. This operation is effective in preventing process troubles because the valve can be operated remotely and monitored in real time.

The emergency shutoff valve is installed on the pipe at the top of the reactor and automatically blocks the flow of fluid (ammonia) when operating conditions are abnormal to prevent secondary disasters. In addition, the emergency shutoff valve is a safety device that must be able to withstand the set pressure and the set temperature of the device and operates to block ammonia fed to the reactor and to prevent secondary disasters when the operating conditions are out of the set levels during operation.

In the present disclosure, the first, second and third reactors are connected in parallel with each other.

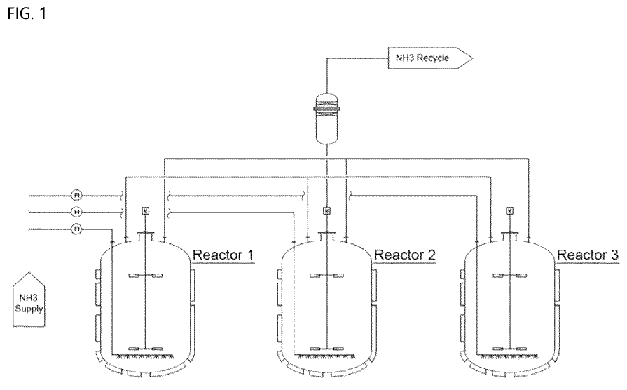

Referring to FIG. 1, each reactor is connected to an ammonia feeder (NH₃ supply unit) configured to supply ammonia to the reactor and an ammonia collector (NH₃ recycle unit) configured to collect ammonia from the reactor and exchange ammonia therewith.

The ammonia feeder and the ammonia collector are connected to each other, and the ammonia collector can transfer the ammonia collected from the reactor to the ammonia feeder. The ammonia feeder and the ammonia collector may be integrated with each other.

In a preferred embodiment, the ammonia feeder of the present disclosure supplies ammonia to the bottom of the reactor. By feeding ammonia to the bottom of the reactor, the bond between fatty acids and ammonia can be more activated.

The ammonia collector may further include an ammonia regenerator configured to regenerate the collected ammonia. In this case, the ammonia regenerator may be equipped with a cooler, for example, to liquefy the collected gaseous ammonia.

In another embodiment, when the ammonia regenerator is not included, a method of cooling the pipe feeding ammonia with cooling water or the like to liquefy the ammonia inside the transfer pipe may be used.

In the present disclosure, the number of the ammonia feeder and the number of the ammonia collector may be one or two, but each thereof is preferably one in terms of equipment cost reduction.

In a preferred embodiment, the present disclosure uses one ammonia feeder and one ammonia collector to supply ammonia to all three reactors and collect ammonia therefrom.

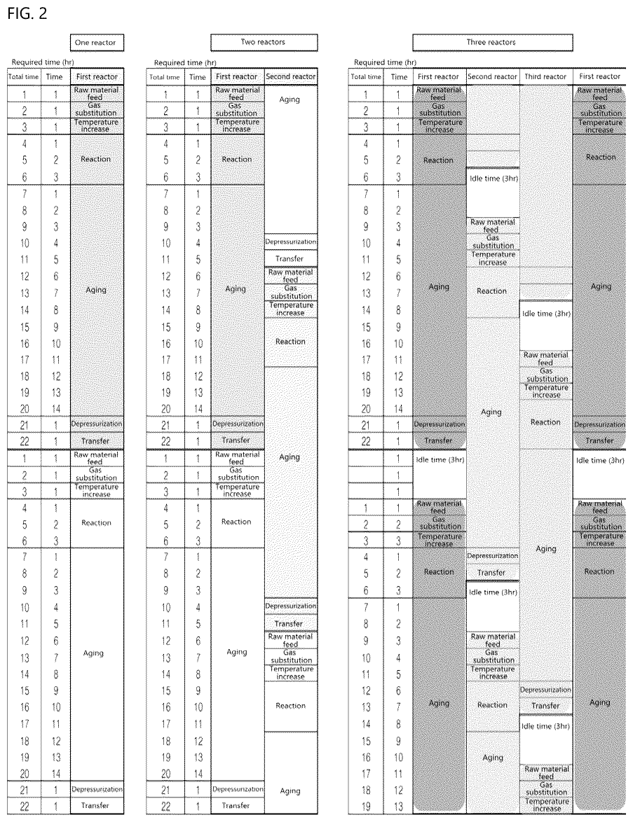

Referring to FIG. 2, in the present disclosure, ammonia is fed by direct movement from one reactor to another reactor or is fed by the ammonia feeder during the reaction, and is collected during depressurization.

In one embodiment, in the present disclosure, the ammonia may be fed directly from the first reactor to the third reactor, the ammonia may be fed directly from the second reactor to the first reactor, and the ammonia may be fed directly from the third reactor to the second reactor. In addition, in the present disclosure, the ammonia collected from the first reactor by the ammonia collector may be fed to the third reactor by the ammonia feeder, and the ammonia collected from the second reactor by the ammonia collector may be fed to the first reactor by the ammonia feeder during the reaction, and the ammonia collected from the third reactor by the ammonia collector may be fed to the second reactor by the ammonia feeder. By continuously repeating the above process, ammonia can be continuously fed to three reactors by one ammonia feeder and one ammonia collector. As described above, the present disclosure has the effect of feeding ammonia at high speed and with low energy consumption through direct ammonia supply from one reactor to another reactor. In addition, the present disclosure can reduce ammonia usage and minimize air pollution by reusing the ammonia collected in this way. However, in order to reuse ammonia in this way, it is necessary to control the operating cycle of each reactor, and to operate each reactor at a time interval to complete each cycle.

For this purpose, in the present disclosure, when the reaction is performed simultaneously in the first reactor and the second reactor, the third reactor does not participate in the reaction and performs preparatory operations for the reaction including raw material feeding, gas substitution (nitrogen substitution), reactor temperature increase, and the like. In this case, the time for preparatory operations may be, for example, 1 to 5 hours, 2 to 4 hours, or about 3 hours. When the reaction in the first reactor is completed, the third reactor, preparatory operation of which has been completed, newly participates in the reaction. That is, at this time, the reaction proceeds simultaneously in the second reactor and the third reactor. Then, when the reaction in the second reactor is completed, the first reactor, preparatory operation of which has been completed, newly participates in the reaction. That is, at this time, the reaction proceeds simultaneously in the third reactor and the first reactor. In this way, the reaction proceeds sequentially and continuously. Completion of the reaction occurs at the end of the aging step. The time at which the reaction is completed may be within 1 to 5 hours, for example, within 1 hour, within 2 hours, within 3 hours, within 4 hours, or within 5 hours of completion, preferably within 1 hour or within 2 hours, and more preferably within 1 hour of completion.

In a preferred embodiment, referring to FIG. 2, the feeding of raw materials to the second reactor begins about 3 hours after the first reactor begins aging. That is, at this time, the aging is performed for 3 hours in the first reactor, and the aging is performed for 12 hours in the third reactor. That is, the first and third reactors are participating in reaction, whereas the second reactor is preparing for reaction.

In the reactor where the reaction has been completed, a predetermined idle time, after steps such as depressurization, cooling, and reactant transfer, preparatory operations for the reaction, such as feeding of raw materials, gas substitution (nitrogen substitution), and increasing the reactor temperature start again. The operating time for steps involving depressurization, cooling, reactant transfer, etc., may take, for example, 1 to 5 hours, 1 to 3 hours, or about 2 hours.

In the present disclosure, each reactor has a predetermined idle time after completing one cycle. The idle time may be between 2 and 4 hours, for example about 3 hours. In the present disclosure, the idle time enables preparation of the subsequent process, which can provide advantages such as long-term stable operation and shortened process time.

In one embodiment, the reactor in which the reaction is completed transfers the reactants to the subsequent process, is allowed to stand for an idle time of 3 hours, and then restarts feeding of raw materials.

As described above, in the present disclosure, the first reactor, the second reactor, and the third reactor are operated with a time interval to complete each cycle, and the fatty acid derivative that has completed the reaction process in the first, second, and third reactors is fed subsequently, continuously, and stably to the subsequent disposer, thus having advantages of being free of stopping of the process and having increased production volume and reduced production costs.

In the disposer, caustic soda (NaOH, sodium hydroxide) is added to the fatty acid derivative that underwent reaction in the reaction process to separate unreacted fatty acids from the fatty acid derivative that underwent reaction.

The purifier purifies only fatty acid derivatives that have completed the reaction to high purity.

High-purity fatty acid derivatives are powdered by a powderizer and packaged by a packager.

Hereinafter, the method of preparing fatty acid derivatives according to the present disclosure will be described in detail.

The amidation for preparing fatty acid derivatives does not proceed as easily as a simple acid-alkali reaction, but should be performed under specific conditions (temperature, pressure, time) in order to prevent additional reactions and to obtain high-purity amides. In the present disclosure, the amidation process includes raw material (fatty acid) feed, gas substitution, temperature increase, ammonia feed and reaction, aging, depressurization, and transfer of reactants to subsequent processes, and this reaction process is the main cause of high productivity. The present disclosure provides optimized production steps and reaction conditions for the preparation of fatty acid derivatives.

The method of preparing fatty acid derivatives according to the present disclosure includes raw material feeding of feeding fatty acid to a reactor, gas exchange of feeding nitrogen to the reactor to make the atmosphere of the reactor inert, reactor temperature raising of raising an internal temperature of the reactor to 120° C. or higher, reaction including feeding ammonia to the reactor using an ammonia feeder to perform a reaction of ammonia with fatty acids, aging to allow the reaction to complete while controlling an amount of ammonia fed and maintaining the reactor temperature, depressurization of stopping the feed of ammonia and removing the pressure inside the reactor, and transfer of transferring the depressurized reactants inside the reactor.

In the present disclosure, in the raw material feeding of feeding, a reactant, i.e., fatty acid, from the raw material storage tank to a reactor, the fatty acid may be erucic acid, oleic acid, stearic acid, behenic acid or the like.

Once the feeding of raw materials is completed, gas exchange of feeding nitrogen to the reactor to make the atmosphere of the reactor inert is performed. In one embodiment, this step is performed inside the reactor through a multi-step process including nitrogen feed (2 bar)→exhaust (0 bar), vacuum (40 mmHgV)→nitrogen feed (2 bar)→exhaust (0 bar), →vacuum (40 mmHgV) to remove residual oxygen inside the reactor and prevent oxidation of the reactants.

The reactor temperature raising is a step to prepare for the reaction by supplying high-temperature steam and high-temperature oil to a reactor coil to raise the internal temperature of the reactor to 120° C. or higher. In the present disclosure, the internal temperature is 120° C. to 230° C., preferably 140° C. to 210° C., and more preferably 160° C. to 200° C. When the internal temperature is lower than 120° C., the reactivity of fatty acids with ammonia may decrease and entrainment may occur. When the internal temperature is higher than 230° C., quality problems may occur due to increased pressure inside the reactor and product deterioration, and impurities (for example, nitrile) may be produced due to side reactions.

Each of the raw material feeding, the gas exchange and the reactor temperature raising is preferably performed for about 1 hour, for example, 10 minutes to 2 hours, or may be performed within a suitable time within the range defined above.

Then, when the reactor temperature reaches a predetermined level, reaction including feeding ammonia to the reactor using an ammonia feeder to perform a reaction with fatty acids is performed. The feed of ammonia in the reaction stage is achieved through natural pressure equalization, flowing from high pressure to low pressure. At this time, the ammonia feed rate is 100 Nm³/hr to 1,000 Nm³/hr, preferably 200 Nm³/hr to 600 Nm³/hr, more preferably 300 Nm³/hr to 500 Nm³/hr, and most preferably 400 Nm³/hr. Maintaining the feed rate is advantageous in terms of reaction activity. The reaction in the reaction step is performed at a temperature of 120° C. to 230° C., preferably 140° C. to 210° C., more preferably 160° C. to 200° C., for 1 to 5 hours, preferably 1.5 to 4.5 hours, more preferably 2 to 4 hours, most preferably 3 hours. In addition, maintaining the pressure at 0.5 to 4 bar, more preferably 1 to 3 bar, and more preferably 2 to 3 bar, is advantageous in terms of reaction activity. When the reaction time is less than 1 hour, there is a problem that the reaction rate is decreased and the reaction is delayed, and when the reaction time is longer than 5 hours, a problem occurs in which large amounts of impurities (e.g., nitrile) are generated due to the additional reaction. In addition, when the reaction temperature is lower than 120° C., the reactivity of fatty acids with ammonia may decrease, causing entrainment, and when the reaction temperature is higher than 230° C., quality problems may occur due to increased pressure inside the reactor and product deterioration, and impurities (for example, nitrile) may be produced due to side reactions. In addition, when the reaction pressure is lower than 0.5 bar, the reaction speed is decreased and the reaction is delayed, and when the reaction pressure is higher than 4 bar, a problem of entrainment may occur.

After the reaction step, aging to allow the reaction to complete is performed by controlling the amount of ammonia fed while maintaining the reactor temperature. At this stage, it is important to ensure that the reaction ends naturally by controlling the amount of ammonia fed. The amount of ammonia fed is adjusted to 200 to 1,500 Nm³/hr, preferably 300 to 1,200 Nm³/hr, more preferably 600 to 1,000 Nm³/hr, and most preferably 900 Nm³/hr. By adjusting the amount of ammonia fed as described above, the effect of efficiently completing the reaction can be achieved.

The aging in the aging step is performed at a temperature of 130° C. to 240° C., preferably 150° C. to 220° C., more preferably 170° C. to 210° C., for 10 to 18 hours, preferably 12 to 16 hours, more preferably 13 to 15 hours, most preferably 14 hours. In addition, the pressure is 6 to 10 bar, preferably 7 to 9 bar, and more preferably 8 to 9 bar. When the aging time is less than 10 hours, there is a problem that the reaction rate is decreased and the reaction is delayed, and when the aging time is longer than 18 hours, a problem occurs in which large amounts of impurities (e.g., nitrile) are generated due to the additional reaction. In addition, when the reaction temperature is lower than 130° C., the reactivity of fatty acids with ammonia may decrease, causing entrainment, and when the reaction temperature is higher than 240° C., quality problems may occur due to increased pressure inside the reactor and product deterioration, and impurities (for example, nitrile) may be produced due to side reactions. In addition, when the reaction pressure is lower than 6 bar, the reaction speed is decreased and the reaction is delayed, and when the reaction pressure is higher than 10 bar, safety problems such as equipment damage due to increased internal pressure may occur.

After the reaction is completed, the reactor stops feeding ammonia and performs depressurization to remove the pressure from the reactor. The depressurization in this step includes direct depressurization from one reactor to another reactor not involved in the reaction and depressurization by the ammonia collector. For example, depressurization in the first reactor from 8 to 2 bar may be achieved through direct depressurization to the third reactor, and depressurization from 2 to 0 bar may be achieved by the ammonia collector. That is, depressurization from 8 to 2 bar means depressurization of ammonia gas by the third reactor not involved in the reaction, that is, in the reaction preparation stage, and depressurization from 2 to 0 bar means depressurization by the ammonia collector. The present disclosure has the advantage of reducing ammonia consumption through depressurization by the reactor as described above and additional depressurization in the ammonia collector and reducing the load on environmental pollution prevention facilities.

Then, transfer of transferring the depressurized reactants from the reactor to the subsequent process is performed.

After the transfer, each reactor has an idle time of 1 to 5 hours, preferably 1.5 to 4.5 hours, more preferably 2 to 4 hours, and most preferably 3 hours, and then performs raw material feeding again. This idle time has a particularly advantageous effect when producing fatty acid derivatives using three reactors. During the idle time, the reactor can be inspected and preliminary preparation for the subsequent process can be made, thereby shortening the process time.

The method of the present disclosure includes treatment of separating the reacted fatty acid derivative from the transferred reactant after the transfer, purification of purifying the reacted fatty acid derivative separated during the treatment, powdering the fatty acid derivative purified during the purification, and packaging of packaging the powdered fatty acid derivative.

The treatment of separating the reacted fatty acid derivative from the transferred reactant is a step of adding caustic soda (NaOH, sodium hydroxide) to the reacted fatty acid during the reaction to separate the unreacted fatty acid from the reacted fatty acid derivative. During the treatment, the reacted fatty acid derivative is separated from the unreacted fatty acid, and the reacted fatty acid derivative is transferred to the purification step.

In the purification step, only the reacted fatty acid derivative is purified to high purity and in the powdering step, the high purity fatty acid derivative is powdered and packaged in the packaging step.

In a preferred embodiment of the present disclosure, the method for preparing the fatty acid derivative is performed using three reactors including a first reactor, a second reactor, and a third reactor.

In the present disclosure, the first reactor, the second reactor, and the third reactor are preferably operated at a time interval. In terms of production cost and efficiency, the time interval is preferably well controlled. One ammonia feeder and one ammonia collector may be used in all three reactors. 6 to 10 hours, preferably 7 to 9 hours, more preferably 7.5 to 8.5 hours, and most preferably 8 hours after the feed of raw materials into the first reactor, the feed of raw materials to the second reactor starts. 6 to 10 hours, preferably 7 to 9 hours, more preferably 7.5 to 8.5 hours, and most preferably 8 hours after the feed of raw materials into the second reactor, the feed of raw materials into the third reactor starts. 6 to 10 hours, preferably 7 to 9 hours, more preferably 7.5 to 8.5 hours, and most preferably 8 hours after the feed of raw materials into the third reactor, the feed of raw materials into the first reactor starts. By repeating the above process, a continuous process is achieved and one ammonia feeder and one ammonia collector may be used in all three reactors.

In the method using three reactors of the present disclosure, when the reaction is performed in the first reactor and the second reactor, the third reactor does not participate in the reaction and performs pre-preparation operations for the reaction including raw material feeding, gas exchange, and reactor temperature increase. In addition, when the reaction is performed in the second reactor and the third reactor, the first reactor does not participate in the reaction, and performs pre-preparation operations for the reaction including raw material feeding, gas exchange, and reactor temperature increase. In addition, when the reaction is performed in the third reactor and the first reactor, the second reactor does not participate in the reaction and performs pre-preparation operations for the reaction including raw material feeding, gas exchange, and reactor temperature increase.

In the process using three reactors of the present disclosure, when the reaction in the first reactor is completed, that is, when the aging is completed, the third reactor, the preparatory operation of which has been completed newly participates in the reaction. In addition, when the reaction in the second reactor is completed, that is, upon completion of the aging step, the first reactor, the preparatory operation of which has been completed newly participates in the reaction. In addition, at the point when the reaction in the third reactor is completed, that is, when the aging step is completed, the second reactor, the preparatory operation of which has been completed newly participates in the reaction. In this way, the specifically adjusted reaction participation time according to the present disclosure allows all three reactors to perform the process in concert, thus providing excellent productivity and efficiency.

As described above, in line with the reaction participation time of each reactor, in the present disclosure, the ammonia recovered from the first reactor by the ammonia collector is fed into the third reactor by the ammonia feeder, the ammonia recovered from the third reactor by the ammonia collector is fed into the second reactor by the ammonia feeder, and the ammonia recovered from the second reactor by the ammonia collector is re-fed into the reaction stage of the first reactor by the ammonia feeder. By repeating this process, one ammonia feeder can continuously feed ammonia to the reactor. By using the ammonia recovered in this way, the amount of ammonia used can be reduced and air pollution can be minimized.

According to the present disclosure, Table 1 below shows excellent hourly production, daily production, and production cost (efficiency) compared to the production of fatty acid derivatives using one or two reactors.

TABLE 1

| Item | One reactor | Two reactors | Three reactors |
|---|---|---|---|
| Reaction time (hr/batch) | 22 | 22 | 22 |
| Unit production | 15 | 15 | 15 |
| (ton/reactor) | | | |
| Batch Time (hr/batch) | 22.0 | 11.0 | 7.3 |
| Production per time | 0.68 | 1.36 | 1.88 |
| (ton/hr) | | | |
| Daily production (ton/day) | 16.4 | 32.7 | 49.1 |
| Production cost (efficiency) | 100 | 150 | 200 |

As can be seen from Table 1 above, compared to when using two reactors, when using three reactors, productivity can be improved by reducing the reaction time as shown below.
Shortened reaction time (hr/batch): 11 hours→7.3 hours (27% reduction)
Increase in production (ton/day): 32.7 tons→49.1 tons (50% increase in productivity)
Manufacturing cost (KRW/ton): KRW 300,000→KRW 150,000 (50% reduction)

As above, when using three reactors of the present disclosure, the effects of significantly improving productivity and reducing production costs are obtained compared to when using one or two reactors of the related art.

In addition, according to the present disclosure, despite adding a reactor, the required ammonia is supplied to all three reactors, ammonia is recovered from the three reactors using one ammonia feeder and one ammonia collector as before through control of the reactor cycle and thus it is economical in that efficiency can be expected to improve without adding large equipment costs.

Hereinafter, the present disclosure will be described in more detail with reference to examples. The following examples are provided only for illustration of the present disclosure in more detail and should not be construed as limiting the scope of the present disclosure.

### [Example 1] Preparation of Fatty Acid Derivatives

Fatty acid, which was a reactant, was fed into the reactor, the feed of raw materials was completed, and then nitrogen was fed into the reactor to remove residual oxygen inside the reactor. After raising the temperature of the reactor to 120° C. and maintaining the temperature at 120° C., ammonia was fed into the reactor and reacted with fatty acid. At this time, the pressure of the reactor was maintained at 0.5 bar. After reacting fatty acids with ammonia for about 3 hours, subsequent aging was performed while adjusting the amount of ammonia fed. In the aging step, the reaction product was aged for 14 hours while maintaining the reactor pressure at 10 bar and the reaction temperature at 130° C. to prepare a fatty acid derivative. As a result of measuring the free fatty acid, the conversion rate was 80.5%, and as a result of analyzing the carbon composition using gas chromatography (GC), the nitrile content was 0.1%, identifying that a fatty acid derivative was obtained.

### [Example 2] Preparation of Fatty Acid Derivative

A fatty acid derivative was prepared in the same manner as in Example 1, except that the reaction temperature was 150° C., the reaction pressure was 1 bar, the aging temperature was 160° C., and the aging pressure was 9 bar. As a result of measuring free fatty acid, the conversion rate was 88.1%, and as a result of analyzing the carbon composition using gas chromatography (GC), the nitrile content was 0.3%, identifying that a fatty acid derivative was obtained.

### [Example 3] Preparation of Fatty Acid Derivative

A fatty acid derivative was prepared in the same manner as in Example 1, except that the reaction temperature was 180° C., the reaction pressure was 2 bar, the aging temperature was 190° C., and the aging pressure was 8 bar. As a result of measuring the free fatty acid, the conversion rate was 96.5%, and as a result of analyzing the carbon composition using gas chromatography (GC), the nitrile content was 0.6%, identifying that an excellent fatty acid derivative was obtained.

### [Example 4] Preparation of Fatty Acid Derivative

A fatty acid derivative was prepared in the same manner as in Example 1, except that the reaction temperature was 210° C., the reaction pressure was 3 bar, the aging temperature was 220° C., and the aging pressure was 7 bar. As a result of measuring the free fatty acid, the conversion rate was 98.2%, and as a result of analyzing the carbon composition using gas chromatography (GC), the nitrile content was 4.8%, identifying that a fatty acid derivative was obtained.

### [Example 5] Preparation of Fatty Acid Derivative

A fatty acid derivative was prepared in the same manner as in Example 1, except that the reaction temperature was 230° C., the reaction pressure was 4 bar, the aging temperature was 240° C., and the aging pressure was 6 bar. As a result of measuring the free fatty acid, the conversion rate was 98.9%, and as a result of analyzing the carbon composition using gas chromatography (GC), the nitrile content was 10.9%, identifying that a fatty acid derivative was obtained.

### [Comparative Example 1] Preparation of Fatty Acid Derivative

A fatty acid derivative was prepared in the same manner as in Example 1, except that the reaction temperature was 110° C. and the aging temperature was 120° C. As a result of measuring the free fatty acid, the conversion rate was 70.4%, and as a result of analyzing the carbon composition using gas chromatography (GC), the nitrile content was 0.1%, identifying that a fatty acid derivative with a low conversion rate was obtained.

### [Comparative Example 2] Preparation of Fatty Acid Derivative

A fatty acid derivative was prepared in the same manner as in Example 1, except that the reaction temperature was 240° C., the reaction pressure was 4 bar, the aging temperature was 250° C., and the aging pressure was 6 bar. As a result of measuring free fatty acid, the conversion rate was 99.1%, and as a result of analyzing the carbon composition using gas chromatography (GC), the nitrile content was 30.8%, identifying that a fatty acid derivative with an increased impurity content was obtained.

### [Comparative Example 3] Preparation of Fatty Acid Derivative

A fatty acid derivative was prepared in the same manner as in Example 1, except that the reaction temperature was 110° C., the reaction pressure was 4 bar, the aging temperature was 120° C., and the aging pressure was 6 bar. As a result of measuring the free fatty acid, the conversion rate was 55.0%, and as a result of analyzing the carbon composition using gas chromatography (GC), the nitrile content was 0.1%, identifying that a fatty acid derivative with a low conversion rate was obtained.

The results are shown in Table 2 below.

TABLE 2

| | Reaction | Reaction | Reaction | Aging | Aging | Aging | | Nitrile |
|---|---|---|---|---|---|---|---|---|
| | temperature | time | pressure | temperature | time | pressure | Conversion | content |
| Item | (° C.) | (hr) | (bar) | (° C.) | (hr) | (bar) | rate (%) | (%) |
| Example 1 | 120 | 3 | 0.5 | 130 | 14 | 10 | 80.5 | 0.1 |
| Example 2 | 150 | 3 | 1 | 160 | 14 | 9 | 88.1 | 0.3 |
| Example 3 | 180 | 3 | 2 | 190 | 14 | 8 | 96.5 | 0.6 |
| Example 4 | 210 | 3 | 3 | 220 | 14 | 7 | 98.2 | 4.8 |
| Example 5 | 230 | 3 | 4 | 240 | 14 | 6 | 98.9 | 10.9 |
| Comparative | 110 | 3 | 0.5 | 120 | 14 | 10 | 70.4 | 0.1 |
| Example 1 | | | | | | | | |
| Comparative | 240 | 3 | 4 | 250 | 14 | 6 | 99.1 | 30.8 |
| Example 2 | | | | | | | | |
| Comparative | 110 | 3 | 4 | 120 | 14 | 6 | 55.0 | 0.1 |
| Example 3 | | | | | | | | |

As can be seen from Table 2 above, Examples of the present disclosure all exhibited overall superior results compared to Comparative Examples. More specifically, all of Examples 1 to 5 of the present disclosure exhibited appropriate ranges of conversion rates and nitrile contents, and Examples 2 to 4, especially, Example 3 exhibited excellent results. On the other hand, Comparative Examples 1 and 3 exhibited a conversion rate less than 80%, which is inapplicable to actual fatty acid derivative production processes. Comparative Example 2 exhibited a content of nitrile, which is an impurity due to the additional reaction, higher than 30%, which indicates that quality deterioration problems occurred when preparing fatty acid derivatives under these conditions.

As is apparent from the foregoing description, the present disclosure may provide a device for preparing a fatty acid derivative including three reactors, a stable supply of reactants is possible even if a problem occurs in one reactor, and continuous and stable operation is possible because delays in the treatment and purification process do not occur. As a result, the device has effects of increasing productivity and reducing production costs. In other words, by operating three reactors instead of two reactors, it is possible to build a production facility that can be operated continuously without stopping, resulting in increased production and reduced production costs.

In addition, in general, the device for preparing a fatty acid derivative must be operated by installing both an ammonia feeder and an ammonia collector in order to operate one reactor. Accordingly, when operating three reactors, three ammonia feeders and collectors are required, but in the present disclosure, the reactors are operated at a time interval, so that only one ammonia feeder and one ammonia collector can be used for all three reactors. As a result, there is no need to prepare additional ammonia feeders and collectors, and there are advantages such as reducing utility costs for preparation.

The above description is merely illustrative of the technical idea of the present disclosure. It will be apparent to those skilled in the art that various modifications and variations can be made in the present disclosure without departing from the spirit or scope of the disclosures.

Therefore, the above detailed description is to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A device for preparing fatty acid derivatives comprising:
a reactor configured to react fatty acids, the reactor comprising a first reactor, a second reactor, and a third reactor, the first, second, and third reactors being connected in parallel;
an ammonia feeder configured to feed ammonia and be connected to each of the first, second and third reactors;
an ammonia collector configured to collect ammonia and be connected to each of the first, second and third reactors;
a disposer configured to separate the reacted fatty acid derivative from the fatty acid reacted in the reactor; and
a purifier configured to purify the reacted fatty acid derivative separated by the disposer,
wherein the ammonia feeder and the ammonia collector are connected to each other to exchange ammonia, and all of the first, second, and third reactors receive ammonia from the ammonia feeder, and
the first, second and third reactors are operated at a time interval from each other to complete each cycle, the fatty acid derivatives that have completed the reaction in the first, second and third reactors are sequentially and continuously fed into the disposer, and each reactor has an idle time after one cycle.

2. The device according to claim 1, further comprising:
a powderizer configured to powder the fatty acid derivative purified by the purifier; and
a packager configured to package the powdered fatty acid derivative.

3. The device according to claim 1, wherein each of the number of the ammonia feeder and the number of the ammonia collector is one.

4. The device according to claim 1, wherein ammonia recovered from the first reactor is fed into the third reactor, ammonia recovered from the second reactor is fed into the first reactor, and ammonia recovered from the third reactor is fed into the second reactor.

5. The device according to claim 1, wherein the ammonia feeder feeds ammonia to a bottom of the reactor.

6. The device according to claim 1, wherein the ammonia collector further comprises an ammonia regenerator configured to regenerate the recovered ammonia.

7. The device according to claim 1, wherein the ammonia feeder and the ammonia collector are integrated.

8. The device according to claim 1, wherein each reactor further comprises at least one of an ammonia flow regulator, an automatic valve, or an emergency shut-off valve.

9. A method of preparing fatty acid derivatives comprising:
raw material feeding of feeding fatty acid to a reactor;
gas exchange of feeding nitrogen to the reactor to make an atmosphere of the reactor inert;
reactor temperature raising of raising an internal temperature of the reactor to 120° C. or higher;
reaction including feeding ammonia to the reactor using an ammonia feeder to perform a reaction with fatty acids;
aging to allow the reaction to complete while controlling an amount of ammonia fed and maintaining the reactor temperature;
depressurization of stopping the feed of ammonia and removing the pressure in the reactor; and
transfer of transferring the depressurized reactants inside the reactor.

10. The method according to claim 9, further comprising:
treatment of separating the reacted fatty acid derivative from the transferred reactant after the transfer;
purification of purifying the reacted fatty acid derivative separated during the treatment;
powdering the fatty acid derivative purified during the purification; and
packaging of packaging the powdered fatty acid derivative.

11. The method according to claim 9, wherein, after the transfer, the reactor has an idle time of 1 to 5 hours and then starts the raw material feeding again.

12. The method according to claim 9, wherein the reaction in the reaction step is performed at a temperature of 120° C. to 230° C. and a pressure of 0.5 to 4 bar for 1 to 5 hours.

13. The method according to claim 9, wherein the aging in the aging step is performed at a temperature of 130° C. to 240° C. and a pressure of 6 to 10 bar for 10 to 18 hours.

14. The method according to claim 9, wherein the reactor comprises a first reactor, a second reactor and a third reactor.

15. The method according to claim 14, wherein the first reactor, the second reactor and the third reactor are operated at a time interval.

16. The method according to claim 15, wherein, regarding the time interval, 6 to 10 hours after the feed of raw materials into the first reactor, the feed of raw materials into the second reactor starts, 6 to 10 hours after the feed of raw materials into the second reactor starts, the feed of raw materials into the third reactor starts, and 6 to 10 hours after the feed of raw materials into the third reactor starts, the feed of raw materials into the first reactor starts.

17. The method according to claim 14, wherein, when the reaction is performed simultaneously in the first reactor and the second reactor, the third reactor does not participate in the reaction and performs preparatory operations for the reaction including raw material feeding, gas substitution, and reactor temperature increase.

18. The method according to claim 14, wherein, when the reaction of the first reactor is completed, the third reactor, the preparatory operations of which have been completed, newly participates in the reaction.

19. The method according to claim 14, wherein, when the reaction of the second reactor is completed, the first reactor, the preparatory operations of which have been completed, newly participates in the reaction.

20. The method according to claim 14, wherein the ammonia collected from the first reactor is fed to the third reactor by the ammonia feeder, the ammonia collected from the second reactor is fed to the first reactor, and the ammonia collected from the third reactor is fed to the second reactor.
